(19) United States
(12) Patent Application Publication
(10) Pub. No.: US 2007/0130769 A1
(43) Pub. Date: Jun. 14, 2007

(54) Micro heat pipe with pligonal cross-section manufactured via extrusion or drawing

(76) Inventors: Seok Hwan Moon, Daejeon-city (KR); Ho Gyeong Yun, Iksan-city (KR); Sang Choon Ko, Daejeon-city (KR); Gunn Hwang, Seoul (KR); Tae Goo Choy, Daejeon-city (KR); Chi Hoon Jun, Daejeon-city (KR); Youn Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/701,610

(22) Filed: Feb. 1, 2007

Related U.S. Application Data
(62) Division of application No. 11/352,006, filed on Feb. 10, 2006.
Application No. 11/352,006 is a continuation of application No. 10/654,686, filed on Sep. 3, 2002, now abandoned.

(30) Foreign Application Priority Data
Dec. 17, 2002 (KR) 2002-80869

(51) Int. Cl. B23P 6/00

(52) U.S. Cl. 29/890.032; 165/104.26

(57) ABSTRACT

A method for fabricating a metal micro heat pipe with a polygonal cross-section to allow working fluid to flow by capillary force generated at edges of the polygonal of the micro heat pipe. The polygonal cross-section is formed of a single metal layer via a single drawing process. The micro heat pipe is formed of a single metal plate.

This application is a Divisional of U.S. patent application Ser. No. 11/352,006 filed on Feb. 10, 2006, which is a Continuation of U.S. patent application Ser. No. 10/654,686 filed on Sep. 3, 2003, which claims the priority of Korean Patent Application No. 2002-80869, filed on Dec. 17, 2002, in the Korean Intellectual Property Office.

### BACKGROUND

1. Field of the Invention

The present invention relates to a heat pipe, and more particularly, to a micro heat pipe for small, thin-film type electronic devices.

2. Description of the Related Art

With the advances of semiconductor manufacturing related technologies, chips packaged in electronic devices and systems have become smaller and have become more highly integrated. However, such chips and systems generate a larger amount of heat per unit area, so that effective cooling techniques are required. Specially, the latest small, thin-film type electronic devices require much smaller cooling devices.

Conventionally, heat sinks, fans, small circular heat pipes having a diameter of 3 mm or greater, and the like have been used to cool small electronic devices. So far, heat sinks have been widely used as basic cooling devices because their size and thickness can be easily varied in the manufacturing process. However, as the size of heat sinks is reduced more and more, the heat dissipating area becomes smaller and the heat dissipating rate becomes lower. Meanwhile, fans have a limitation in that their size cannot be reduced unlimitedly. In addition, the fans are less reliable than other cooling devices.

A small heat pipe with a circular cross-section having a diameter of 3 mm or greater can be compressed to be suitable for a thin-film type structure. However, when such a heat pipe is compressed, a wick thereof undergoes structural changes, and the heat transferring performance is greatly deteriorated. Therefore, there is a need to manufacture a micro heat pipe having a diameter of 3 mm or less for small, thin-film type electronic devices.

### SUMMARY OF THE INVENTION

The present invention provides a micro heat pipe suitable for small, thin-film type electronic devices.

In accordance with an aspect of the present invention, there is provided a micro heat pipe with a polygonal cross-section that is manufactured via drawing and has flat or concave sides to allow working fluid to flow by capillary force generated at the edges of the micro heat pipe.

According to specific embodiments of the above micro heat pipe, the micro heat pipe may have at least one flat side. The polygonal cross-section of the micro heat pipe may be triangular or rectangular. Alternatively, a plurality of micro heat pipes with a polygonal cross-section are combined together in parallel to allow working fluid to flow by capillary force generated at the edges of each of the micro heat pipes.

Another micro heat pipe according to the present invention is manufactured by forming a plurality of through holes with a polygonal cross-section in a metal plate via extrusion, in which each of the through holes has flat or concave sides to allow working fluid to flow by capillary force generated at the edges of each of the through holes.

In this case, the through holes may have irregular sides. The through holes may be interconnected in groups. The polygonal cross-section of the through holes may be triangular or rectangular.

The present invention also provides a micro heat pipe comprising a plurality of micro heat pipes with a polygonal cross-section sealed with a metal plate manufactured via extrusion, in which the plurality of micro heat pipes have flat or concave sides to allow working fluid to flow by capillary force generated at the edges of each of the through holes. The plurality of micro heat pipes may have at least one flat side. The polygonal cross-section of the micro heat pipes may be triangular or rectangular.

As described above, a micro heat pipe according to the present invention can be manufactured easily via simple drawing or extrusion. The micro heat pipe according to the present invention can induce strong capillary force through simple structural modifications, without need to install a separate wick for flowing working fluid.

### BRIEF DESCRIPTION OF THE DRAWINGS

The above and other features and advantages of the present invention will become more apparent by describing in detail exemplary embodiments thereof with reference to the attached drawings in which:

FIGS. 1A through 1C are perspective views of micro heat pipes having a triangular cross-section according to an embodiment of the present invention;

FIGS. 2A through 2C are perspective views of micro heat pipes having a rectangular cross-section according to another embodiment of the present invention;

FIGS. 3A and 3B are perspective views of groups of micro heat pipes having a triangular or rectangular cross-section according to another embodiment of the present invention;

FIGS. 4A through 4D are perspective views of multi-through hole micro heat pipes having a triangular or rectangular cross-section according to another embodiment of the present invention; and

FIG. 5 is a perspective view of sealed micro heat pipes having a rectangular cross-section according to still another embodiment of the present invention.

### DETAILED DESCRIPTION OF THE INVENTION

The present invention will be described more fully with reference to the accompanying drawings, in which exemplary embodiments of the invention are shown. This invention may, however, be embodied in many different forms and should not be construed as being limited to the embodiments set forth herein; rather, these embodiments are provide so that this disclosure will be thorough and complete, and will fully convey the concept of the invention to those skilled in the art.

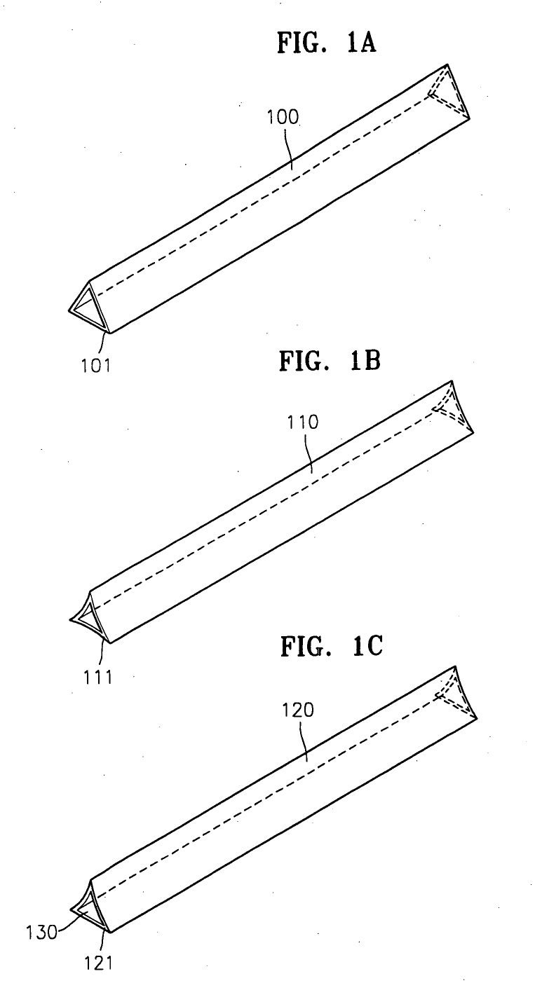

Referring to FIGS. 1A through 1C, which are perspective views of micro heat pipes having a triangular cross-section according to an embodiment of the present invention, the micro heat pipes are manufactured via drawing. Working fluid is allowed to flow by capillary force generated at the edges 101, 111, and 121 of the micro heat pipes and a wick acting as a return path of the working fluid from a condenser section toward an evaporator section is not required. In other words, in the micro heat pipes with a triangular cross-section according to the present invention, their sharp edges act as a wick.

In particular, the micro heat pipe of FIG. 1A with a triangular cross-section has three flat sides 100. The micro heat pipe of FIG. 1B with a triangular cross-section has three concave sides 110. The micro heat pipe of FIG. 1C with a triangular cross-section has two concave sides 120 and one flat surface 130.

The micro heat pipes of FIGS. 1A through 1C may be made of metal, such as copper, easily via drawing. However, for the micro heat pipe of FIG. 1A having the flat sides, the capillary radius is not small enough to induce capillary force at its edges 101. To make the radius of curvature at the edges 101, 111, and 121 of the micro heat pipes as small as possible, each side of the micro heat pipe may be concaved, like the sides 110 of the micro heat pipe in FIG. 1B.

When each side of the micro heat pipe with a triangular cross-section is made concave, a capillary force that is strong enough to induce liquid flow can be generated due to the sharp edges 111. However, in order for the micro heat pipe to be easily and stably packed onto a surface of a target heat-generating source, it is preferable that the micro heat pipe is made to have at least one flat side, like the side 130 of the micro heat pipe in FIG. 1C.

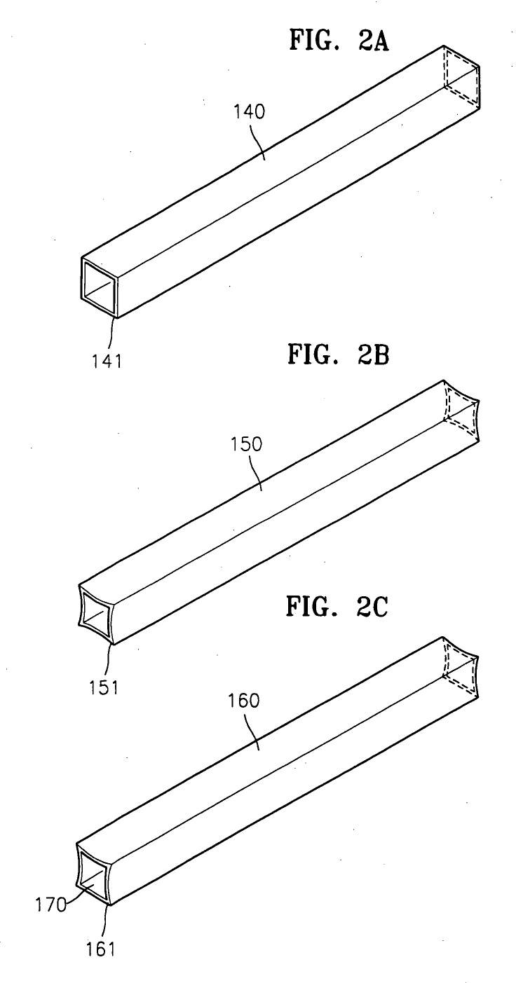

FIGS. 2A through 2C are perspective views of micro heat pipes with a rectangular cross-section according to another embodiment of the present invention.

Like the micro heat pipes of FIGS. 1A through 1C, the micro heat pipes having a rectangular cross-section in FIGS. 2A through 2C are manufactured via drawing. Working fluid is allowed to flow by capillary force generated at the edges 141,151, and 161 of the micro heat pipes and a wick acting as a return path of the working fluid from a condenser section toward an evaporator section is not required. In other words, in the micro heat pipes with a rectangular cross-section according to the present invention, their sharp edges act as a wick.

In particular, the micro heat pipe of FIG. 2A with a rectangular cross-section has four flat sides 140. The micro heat pipe of FIG. 2B with a rectangular cross-section has four concave sides 150. The micro heat pipe of FIG. 2C with a rectangular cross-section has three concave sides 160 and one flat surface 170.

Although the capillary radius of the micro heat pipes with a rectangular cross-section of FIGS. 2A through 2C is larger than the capillary radius of the micro heat pipes with a triangular cross-section of FIGS. 1A through 1C, the micro heat pipes of FIGS. 2A through 2C can allow a larger amount of working fluid to flow because they have one more edge 141, 155, or 161 acting as a flow pat of the working fluid.

In general, one or two micro heat pipes are mounted on a central processing unit (CPU) of commercially available notebook computers. The number of micro heat pipes to be mounted is determined by the internal chip-mount structure of the notebook computer and the cooling capacity of each micro heat pipe. However, if more compact electronic devices producing a greater amount of heat and having a thin-film type chip-mount structure is developed in the future, a wick-embedded heat pipe having a diameter of 3 mm or larger cannot be applied any longer. Accordingly, it is anticipated that a micro heat pipe with a triangular or rectangular cross-section that does not require a wick will soon be in demand.

Although the above-embodiments have been described with reference to the micro heat pipes having a triangular or rectangular cross-section, a micro heat pipe according to the present invention may have any polygonal cross-section. It is also obvious that this concept of the present invention utilizing a polygonal cross-sectional structure can be applied to the micro heat pipes described bellows.

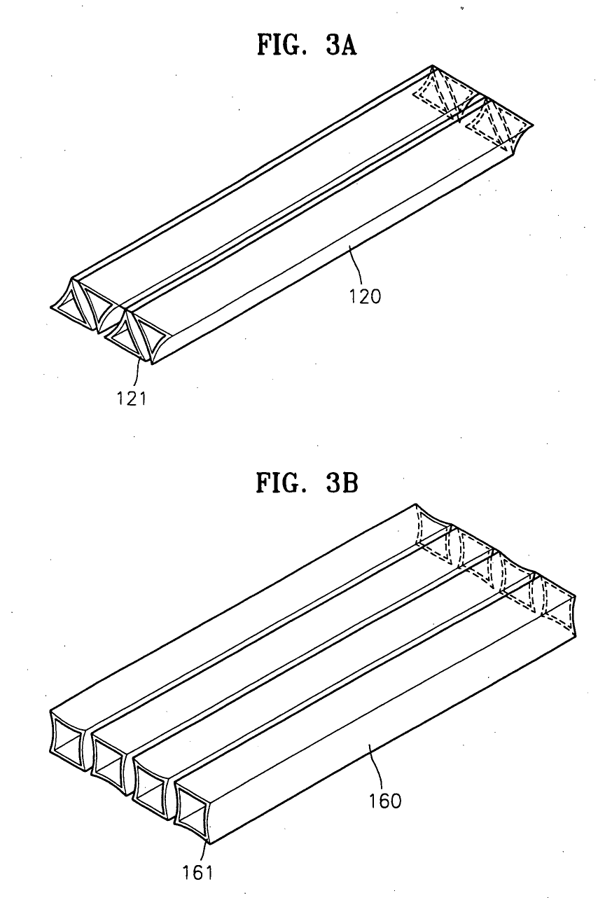

FIGS. 3A and 3B are perspective views of groups of micro heat pipes having a triangular or rectangular cross-section according to another embodiment of the present invention. Reference numerals in FIGS. 3A and 3B that are the same as those in FIGS. 1A through 1C and FIGS. 2A through 2C denote the same elements.

In particular, when there is a need to dissipate a larger amount of heat, the heat cannot be dissipated with only one of the micro heat pipes having a triangular or rectangular cross-section in FIGS. 1A through 1C and FIGS. 2A through 2C. In this case, as illustrated in FIGS. 3A and 3B, a plurality of micro heat pipes having a triangular or rectangular cross-section may be combined together in parallel to increase the absolute heat transfer.

In FIG. 3A, a plurality of micro heat pipes of FIG. 1C are combined together in parallel. Alternatively, a plurality of micro heat pipes of FIG. 1A or 1B may be combined together in parallel. In addition, a plurality of various micro heat pipes of FIGS. 1A through 1C may be combined together in parallel. In FIG. 3B, a plurality of micro heat pipes of FIG. 2C are combined in parallel. Alternatively, a plurality of micro heat pipes of FIG. 2A or 2B may be combined together in parallel. In addition, a plurality of various micro heat pipes of FIGS. 2A through 2C may be combined together in parallel.

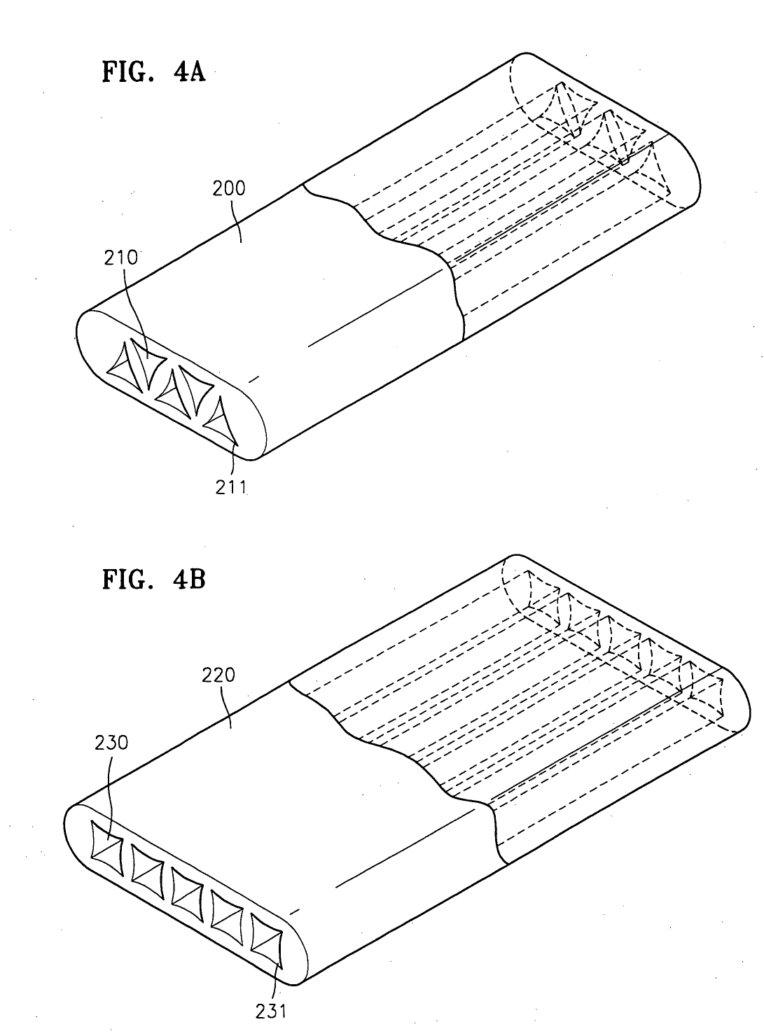

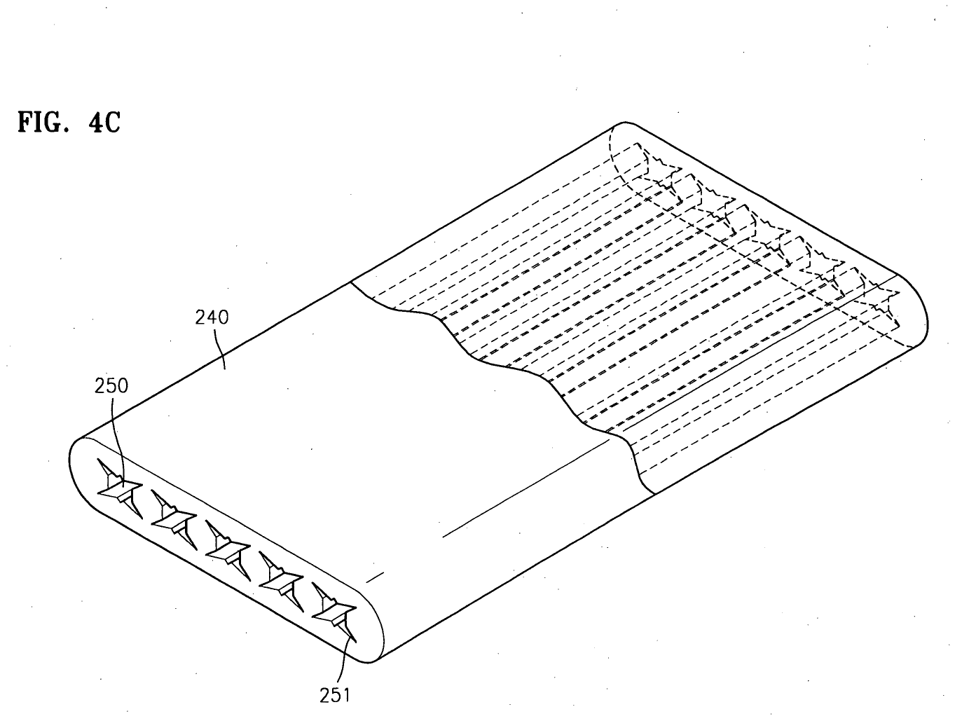

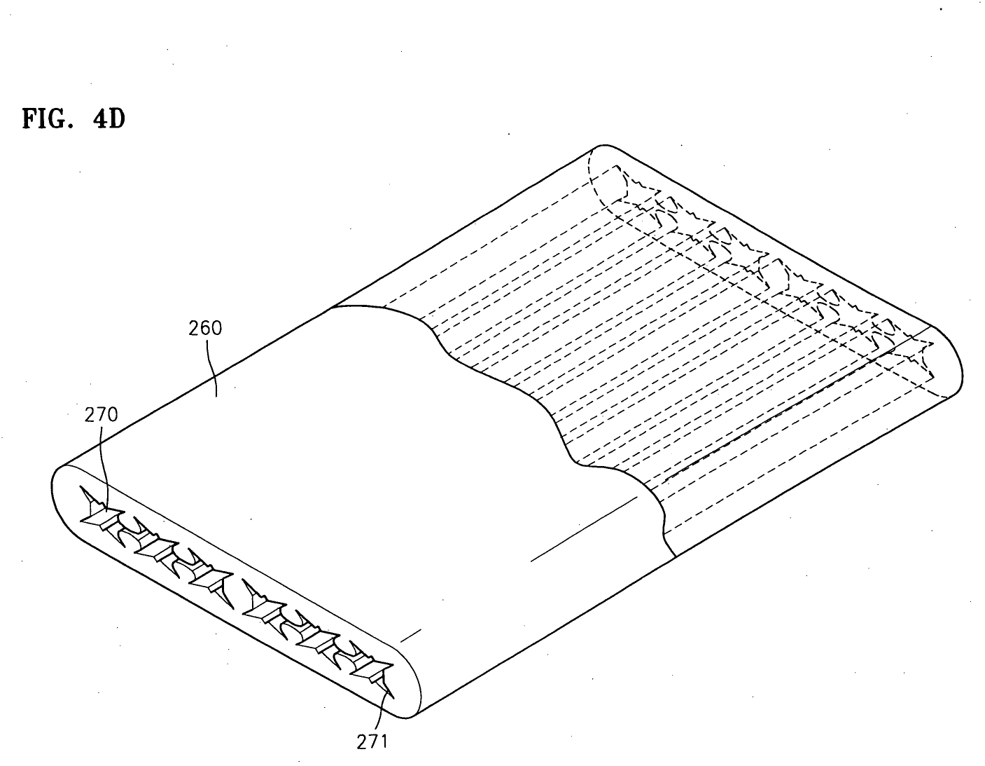

FIGS. 4A through 4D are perspective views of multi-through hole micro heat pipes having a triangular or rectangular cross-section according to another embodiment of the present invention.

In particular, the micro heat pipes of FIGS. 4A through 4D are manufactured from metal plates 200, 220, 240, and 260 via extrusion. The metal plates 200, 220, 240, and 260 may be made of copper or aluminum. A plurality of through holes 210, 230, 250, and 270 with a triangular or rectangular cross-section are formed in the respective metal plates 200, 220,240, and 260. The through holes 210,230,250, and 270 allow working fluid to flow by capillary force generated at the edges 211, 231,251, and 271 thereof.

In particular, the micro heat pipe of FIG. 4A includes a plurality of through holes 210 with a triangular cross-section in the metal plate 200. Each side of the through holes 210 is concave toward outside. It will be obvious that the through holes 210 may have flat sides. In addition, in order to minimize the space occupied by the through holes 210, the through holes 210 with a triangular cross-section may be formed such that their apexes alternate in an upward and downward direction.

The micro heat pipe of FIG. 4B includes a plurality of through holes 230 with a rectangular cross-section in the metal plate 220. Each side of the through holes 230 is concave toward outside. It will be obvious that the through holes 230 may have flat sides.

The micro heat pipe of FIG. 4C includes a plurality of through holes 250 with a polygonal cross-section, which is modified from the rectangular cross-sectional structure of FIG. 4B, in the metal plate 240. The through holes 250 with a polygonal cross-section have irregular sides.

The micro heat pipe of FIG. 4D includes a plurality of through holes 270 with a polygonal cross-section, which are arranged in groups of interconnected through holes, for example, two groups of three interconnected through holes, in the metal plate 260.

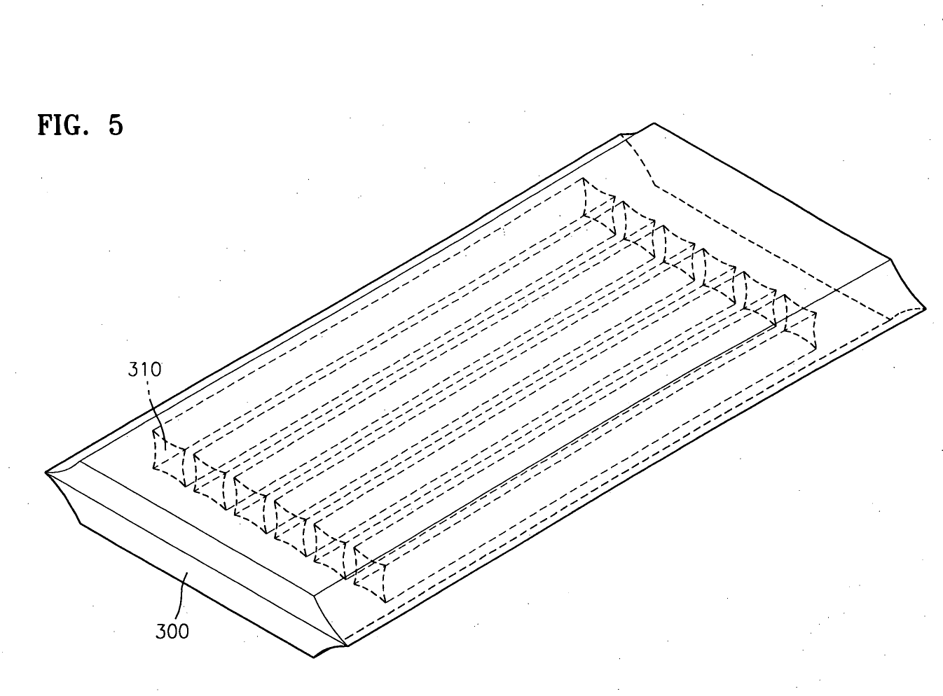

FIG. 5 is a perspective view of sealed micro heat pipes having a rectangular cross-section according to still another embodiment of the present invention.

In particular, the sealed package of micro heat pipes of FIG. 5 includes a metal plate 300. The metal plate 300 is made of copper or aluminum via extrusion. A plurality of micro heat pipes 310 having a rectangular cross-section are closely arranged and sealed with the metal plate 30. In other words, the plurality of micro heat pipes 310 is sealed exclusively with the metal plate 30. In the sealed package of micro heat pipes of FIG. 5, working fluid is allowed to flow by capillary force generated at the edges of each of the micro heat pipes 310.

Although the embodiment of FIG. 5 is illustrated with reference to the micro heat pipes 310 with a rectangular cross-section, it will be obvious that micro heat pipes with any polygonal cross-section, for example, a triangular or rectangular cross-section, as illustrated in FIGS. 1A through 1C and FIGS. 2A through 2C, may be sealed with such a metallic plate. In addition, the micro heat pipes with a polygonal cross-section sealed with the metal plate may have flat or concave sides. Alternatively, the micro heat pipes may have at least one flat side.

As described above, a micro heat pipe according to the present invention allows working fluid to flow by capillary force through structural modifications, without need to install a separate wick. The micro heat pipe according to the present invention can be manufactured easily via drawing or extrusion with higher productivity. The micro heat pipe according to the present invention has a diameter as small as 3 mm or less and effective heat dissipating and heat transfer performance, so that the micro heat pipe according to the present invention is quite suitable as a cooling device for small, thin-film type electronic devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method comprising:
fabricating a metal micro heat pipe with a polygonal cross-section to allow working fluid to flow by capillary force generated at the edges of the micro heat pipe, the polygonal cross-section formed of a single metal layer via a single drawing process, wherein the micro heat pipe is formed of a single metal plate,
wherein the polygonal cross-section is semi-rectangular.

2. The method of claim 1, wherein a plurality of micro heat pipes with a polygonal cross-section are combined together in parallel, and working fluid is allowed to flow by capillary force generated at edges of the polygonal cross-section of each of the micro heat pipes.

3. The method of claim 1, wherein the edges of the metal micro heat pipe act as a wick.

4. A method comprising:
fabricating a metal micro heat pipe with a polygonal cross-section to allow working fluid to flow by capillary force generated at the edges of the micro heat pipe, the polygonal cross-section formed of a single metal layer via a single drawing process, wherein the micro heat pipe is formed of a single metal plate,
wherein the metal heat pipe includes a plurality of interconnected parallel heat pipes having a semi-rectangular cross-section

5. The method of claim 4, wherein a plurality of micro heat pipes with a polygonal cross-section are combined together in parallel, and working fluid is allowed to flow by capillary force generated at edges of the polygonal cross-section of each of the micro heat pipes.

6. The method of claim 4, wherein the edges of the metal micro heat pipe act as a wick.
